(19) United States
(12) Patent Application Publication
(10) Pub. No.: US 2026/0336474 A1
(43) Pub. Date: Oct. 29, 2026

(54) VEHICLE

(71) Applicant: TOYOTA JIDOSHA KABUSHIKI KAISHA, Toyota-shi (JP)

(72) Inventor: Tomoya IWATA, Tokyo-to (JP)

(73) Assignee: TOYOTA JIDOSHA KABUSHIKI KAISHA, Toyota-shi (JP)

(21) Appl. No.: 19/639,935

(22) Filed: Apr. 6, 2026

(30) Foreign Application Priority Data
Apr. 23, 2025 (JP) 2025-071343

(51) Int. Cl. B60L 58/27; B60L 53/14; B60L 53/66

(52) U.S. Cl. CPC B60L 58/27; B60L 53/14; B60L 53/66; B60L 2240/545

(57) ABSTRACT

A vehicle includes an electric heater that heats a battery. A battery ECU includes a memory, intermittently restarts even in a sleep state, and executes temperature rise control for the battery using the electric heater such that a battery temperature approaches a target battery temperature. A charging ECU transmits, to the battery ECU, charger information for the battery ECU to set the target battery temperature. The battery ECU stores the charger information in the memory while the battery ECU is in an activated state. In a case where the battery ECU restarts, when the charging ECU is in an activated state, the battery ECU sets the target battery temperature based on charger information newly acquired from the charging ECU, and, when the charging ECU is in a sleep state, the battery ECU sets the target battery temperature based on the charger information stored in the memory.

### CROSS REFERENCE TO RELATED APPLICATIONS

This nonprovisional application is based on Japanese Patent Application No. 2025-071343 filed on Apr. 23, 2025 with the Japan Patent Office, the entire contents of which are hereby incorporated by reference.

### BACKGROUND

### Field

The present disclosure relates to vehicles and, more particularly, to vehicles that include a heating device that heats a battery.

### Description of the Background Art

When a vehicle equipped with a battery such as a lithium-ion secondary battery is left in an extremely low temperature environment, the electrolyte solution of the battery may freeze. When the electrolyte solution is frozen, the internal resistance of the battery increases, and thus energy loss due to charging and discharging of the battery increases. In addition, in a lithium-ion secondary battery, metallic lithium may be precipitated on the surface of the negative electrode to promote deterioration of the battery (so-called lithium deposition). Japanese Patent Laying-Open No. 2017-147032 discloses a battery system in which heat is applied from the outside of a battery to raise the temperature of the battery, and the battery is used after the temperature is raised.

### SUMMARY

In order to prevent freezing of the electrolyte solution in an extremely low temperature environment and to bring the battery into a state suitable for charging and discharging, it is conceivable to perform "temperature rise control" for the battery using a heating device such as an electric heater such that the temperature of the battery approaches a target temperature.

When the vehicle is left in an extremely low temperature environment for a long time, many management devices including a management device that executes temperature rise control transition into a sleep state. The present inventor focused on the fact that a situation may occur in which the target temperature for the temperature rise control cannot be appropriately set due to activation or sleep of these management devices.

The present disclosure has been made to solve the above-described problem, and one of objects of the present disclosure is to appropriately set a target temperature for temperature rise control.

A vehicle according to an aspect of the present disclosure includes a battery, a heating device that heats the battery, a first management device, and a second management device. The first management device includes a memory, and intermittently restarts even in a sleep state and executes temperature rise control for the battery using the heating device such that a temperature of the battery approaches a target temperature. The second management device transmits, to the first management device, information for the first management device to set the target temperature. The first management device stores the information in the memory while the first management device is in an activated state. In a case where the first management device restarts, when the second management device is in the activated state, the first management device sets the target temperature based on the information newly acquired from the second management device, and when the second management device is in the sleep state, the first management device sets the target temperature based on the information stored in the memory.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an example of an overall configuration of a vehicle according to an embodiment of the present disclosure.

FIG. 2 is a block diagram showing an example of a configuration of a battery ECU.

FIG. 3 is a flowchart illustrating an example of a processing procedure of a vehicle control method according to the embodiment of the present disclosure.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### Embodiments

### Vehicle Configuration

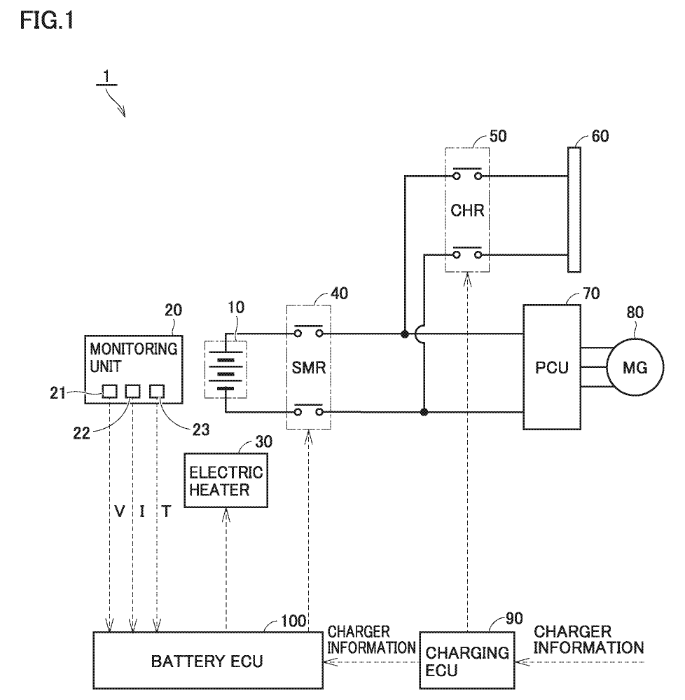

FIG. 1 is a diagram illustrating an example of an overall configuration of a vehicle according to an embodiment of the present disclosure. In this example, the vehicle 1 is a battery electric vehicle (BEV). However, the vehicle 1 is preferably an electrically powered vehicle capable of being charged (so-called external charging) by electric power supplied from an external charger (not shown), and is, for example, a plug-in hybrid electric vehicle (PHEV), a fuel cell electric vehicle (FCEV), or the like. The vehicle 1 may be a hybrid electric vehicle (HEV) as long as it is equipped with a battery.

The vehicle 1 includes a battery 10, a monitoring unit 20, an electric heater 30, a system main relay (SMR) 40, a charge relay (CHR) 50, an inlet 60, a power control unit (PCU) 70, a motor generator (MG) 80, a charging ECU (Electronic Control Unit) (second management device) 90, and a battery ECU (first management device) 100.

The battery 10 is a battery assembly including a plurality of cells. Each cell is a secondary battery, typically a lithium ion battery. However, the type of the cell is not particularly limited. The battery 10 stores electric power for driving the motor generator 80, and supplies the electric power to the motor generator 80 through the PCU 70. The battery 10 is charged by receiving generated electric power through the PCU 70 when the motor generator 80 generates electric power. The battery 10 is also charged by electric power supplied from a charger (not shown).

The monitoring unit 20 includes a voltage sensor 21, a current sensor 22, and a temperature sensor 23. The voltage sensor 21 detects a voltage V of the battery 10 (more specifically, each cell included in the battery). The current sensor 22 detects a current I input to and output from the battery 10. The temperature sensor 23 detects a temperature T of the battery 10 (more specifically, any of the cells included in the battery). Hereinafter, the temperature of the battery 10 detected by the temperature sensor 23 is referred to as a "battery temperature T". Each sensor outputs the detected value to the battery ECU 100.

The electric heater 30 is, for example, a PTC (Positive Temperature Coefficient) heater. The electric heater 30 receives power supply from a power source (which may be an in-vehicle rechargeable battery or an external charger) (not shown) and heats the battery 10 in accordance with a control command from the battery ECU 100. The electric heater 30 corresponds to a "heating device" according to the present disclosure.

The SMR 40 is electrically connected to a power line connecting the battery 10 and the PCU 70. The SMR 40 switches between supply and interruption of power between the battery 10 and the PCU 70 in response to a control command from the battery ECU 100.

The CHR 50 is electrically connected to a power line connecting the battery 10 and the inlet 60. The CHR 50 switches between supply and interruption of power between the battery 10 and the inlet 60 in response to a control command from the charging ECU 90.

The inlet 60 is configured to be electrically connectable to a connector (not shown) of a charging cable. The inlet 60 receives charging power supplied from a charger (not shown) via a charging cable.

The PCU 70 performs bidirectional power conversion between the battery 10 and the motor generator 80 in accordance with a control command from a traveling ECU (not shown). PCU 70 includes, for example, a converter for boosting a DC voltage of battery 10, and an inverter (not shown) for converting DC power from the converter into AC power to drive motor generator 80.

The motor generator 80 is an AC rotating electrical machine, and is, for example, a three-phase AC synchronous motor in which permanent magnets are embedded in a rotor. The motor generator 80 is driven by electric power from the battery 10. On the other hand, when the vehicle 1 is under braking or the acceleration of the vehicle 1 on the downward slope is reduced, the motor generator 80 operates as a generator to perform regenerative power generation. The electric power generated by the motor generator 80 is charged to the battery 10 via the PCU 70.

The charging ECU 90 manages external charging of the vehicle 1. The charging ECU 90 is configured to exchange "charger information" with a charger connected via the inlet 60 and a charging cable when the vehicle 1 is externally charged. The charger information includes, for example, information indicating the maximum power that can be supplied from the charger. The charging ECU 90 corresponds to the "second management device" according to the present disclosure.

The battery ECU 100 manages charging and discharging of the battery 10 so that the battery 10 is protected. In addition, the battery ECU 100 controls the electric heater 30 based on a signal received from each sensor of the monitoring unit 20. More specifically, the battery ECU 100 heats the battery 10 using the electric heater 30 so that the battery temperature T approaches a target battery temperature Ttag in order to prevent freezing of the electrolyte solution of the battery 10 and bring the battery 10 into a state suitable for charging and discharging in an extremely low temperature environment. This control is referred to as "temperature rise control". The battery ECU 100 corresponds to the "first management device" according to the present disclosure.

### Configuration of Battery ECU

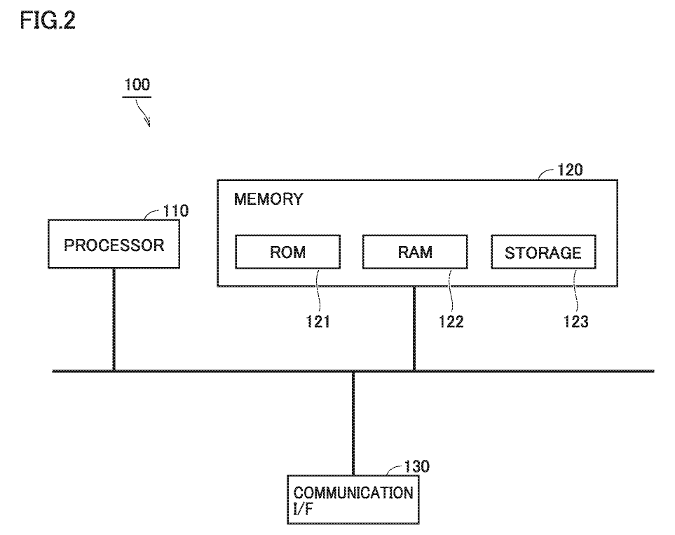

FIG. 2 is a block diagram showing an example of the configuration of the battery ECU 100. Battery ECU 100 includes a processor 110, a memory 120, and a communication interface 130.

The processor 110 includes a central processing unit (CPU), a micro processing unit (MPU), and the like.

The memory 120 includes a read only memory (ROM) 121, a random access memory (RAM) 122, and a storage 123. The RAM includes, for example, DRAM (Dynamic Random Access Memory), SRAM (Static Random Access Memory). The storage 123 includes, for example, a flash memory or the like.

The communication interface 130 is configured to transmit and receive signals to and from other constituent devices (the monitoring unit 20, the electric heater 30, and the charging ECU 90).

The memory 120 stores a system program including an operating system (OS) and a control program for controlling constituent devices of the vehicle 1. The processor 110 implements various processes by reading a system program and a control program and loading them into the memory 120.

### Temperature Rise Control

When the vehicle 1 is left in an extremely low temperature environment for a long period of time, the battery ECU 100 transitions into the sleep state. The battery ECU 100 restarts intermittently even in the sleep state, and executes the temperature rise control when a predetermined condition is satisfied. As a result, the battery temperature T approaches the target battery temperature Ttag of the temperature rise control.

The battery ECU 100 acquires information for setting the target battery temperature Ttag from the charging ECU 90. As one specific example, battery ECU 100 acquires, from charging ECU 90, charger information including information indicating maximum power that can be supplied to vehicle 1 from a charger (not shown), and sets target battery temperature Ttag based on the charger information. For example, the battery ECU 100 sets the target battery temperature Ttag to be higher as the maximum power that can be supplied from the charger is larger. By raising the temperature of the battery 10 as much as possible according to the maximum power prior to external charging, the internal resistance of the battery 10 is lowered, and charging with large power becomes possible. Therefore, the time required for external charging can be reduced.

However, when the vehicle 1 is left in an extremely low temperature environment for a long time, not only the battery ECU 100 but also the charging ECU 90 transitions into the sleep state. Then, the battery ECU 100 cannot acquire the charger information from the charging ECU 90, and as a result, a situation may occur in which the battery ECU 100 cannot appropriately set the target battery temperature Ttag.

Therefore, in the present embodiment, the battery ECU 100 selectively uses the acquisition destination of the charger information depending on whether or not the charging ECU 90 is in the activated state. When the charging ECU 90 is in the activated state, the battery ECU 100 acquires the latest charger information from the charging ECU 90. On the other hand, when the charging ECU 90 is not in the activated state (when the charging ECU 90 is in the sleep state), the battery ECU 100 reads the past (previous) charger information stored in the memory 120 in advance. Accordingly, the battery ECU 100 can acquire the charger information regardless of whether or not the charging ECU 90 is in the activated state, and thus can appropriately set the target battery temperature Ttag.

### Process Flow

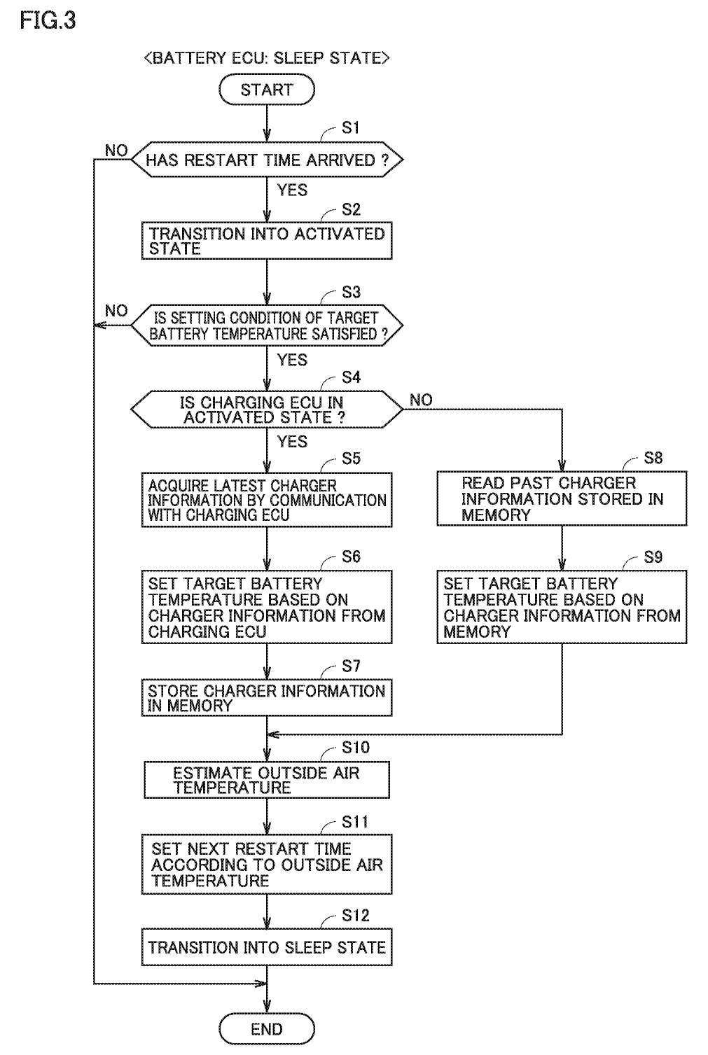

FIG. 3 is a flowchart illustrating an example of a processing procedure of a vehicle control method according to the embodiment of the present disclosure. The process shown in this flowchart is executed when a predetermined condition is satisfied (for example, every predetermined cycle). Each step is implemented by software processing by the battery ECU 100, but may be implemented by hardware (electrical circuit) disposed in the battery ECU 100. Hereinafter, the step is abbreviated as S. It is assumed that the battery ECU 100 is in the sleep state at the start of the series of processes.

In S1, the battery ECU 100 determines whether or not a preset restart time has arrived. When the restart time arrives (YES in S1), the battery ECU 100 transitions from the sleep state into the activated state (S2).

In S3, the battery ECU 100 determines whether or not the setting condition of the target battery temperature Ttag is satisfied. For example, when the battery temperature T is lower than the specified temperature, the setting condition of the target battery temperature Ttag is satisfied. The setting condition of the target battery temperature Ttag may be satisfied when the specified time has already elapsed since the previous setting of the target battery temperature Ttag.

In S4, the battery ECU 100 determines whether or not the charging ECU 90 is in the activated state. For example, when a signal to be transmitted from the charging ECU 90 is received before a predetermined period elapses, the battery ECU 100 determines that the charging ECU 90 is in the activated state. In other words, when the signal is not received before the predetermined period elapses, the battery ECU 100 determines that the charging ECU 90 is not in the activation state (is in the sleep state).

When charging ECU 90 is in the activated state (YES in S4), battery ECU 100 acquires the latest charger information by communication with charging ECU 90 (S5). Then, the battery ECU 100 sets the target battery temperature Ttag based on the latest charger information (particularly, information indicating the maximum power that can be supplied from the charger) (S6). As described above, the battery ECU 100 may set the target battery temperature Ttag to be higher as the maximum power that can be supplied from the charger is larger. Further, the battery ECU 100 stores the charger information acquired in S5 in the memory 120 (for example, SRAM) (S7). Thereafter, the battery ECU 100 advances the process to S10.

When charging ECU 90 is not in the activated state (NO in S4), battery ECU 100 reads the previous charger information stored in memory 120 (S8). Then, the battery ECU 100 sets the target battery temperature Ttag based on the previous charger information (particularly, information indicating the maximum power that can be supplied from the charger) (S9). As in S6, the battery ECU 100 may set the target battery temperature Ttag to be higher as the maximum power that can be supplied from the charger is larger. Thereafter, the battery ECU 100 advances the process to S10.

In S10, the battery ECU 100 estimates the ambient temperature. As one example, the battery ECU 100 estimates the ambient temperature based on a temporal change in the battery temperature T. More specifically, the battery ECU 100 can estimate the ambient temperature from the three parameters (T(n-1), T(n), Δt) by referring to a map in which the relationship between the previous battery temperature T(n-1), the current battery temperature T(n), the time difference Δt therebetween, and the ambient temperature is defined. Alternatively, the battery ECU 100 may acquire a measured value of the ambient temperature from an ambient temperature sensor (not shown). The battery ECU 100 may acquire a measured value (weather information) of the ambient temperature by communication with the outside.

In S11, the battery ECU 100 sets the next restart time. More specifically, the battery ECU 100 sets the next restart time to be earlier as the ambient temperature estimated in S10 is lower. In other words, the battery ECU 100 sets the time from the transition of the battery ECU 100 into the sleep state to the next restart to be shorter as the ambient temperature is lower.

In S12, the battery ECU 100 transitions from the activated state into the sleep state. This completes the series of processes.

As described above, in the present embodiment, even when the charging ECU 90 is in the sleep state at the time of restarting the battery ECU 100, the battery ECU 100 can set the target battery temperature Ttag of the temperature rise control by reading the charger information stored in the memory 120. On the other hand, when the charging ECU 90 is also in the activated state at the time of restarting the battery ECU 100, the battery ECU 100 can set the target battery temperature Ttag based on the latest charger information acquired from the charging ECU 90.

Further, the battery ECU 100 sets the target battery temperature Ttag of the temperature rise control in accordance with the maximum supply power (that is, charging performance) of the charger. As a result, for example, when the charger is a rapid charger, the target battery temperature Ttag is set high to sufficiently raise the temperature of the battery 10, thereby reducing the time required for external charging.

Further, the battery ECU 100 sets the time from the transition of the battery ECU 100 into the sleep state to the restart to be shorter as the ambient temperature is lower. Accordingly, freezing of the electrolyte solution of the battery 10 during the period in which the battery ECU 100 is in the sleep state can be more reliably prevented.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A vehicle comprising:
a battery;
a heating device that heats the battery; and
a first management device that
includes a memory, and
intermittently restarts even in a sleep state and executes temperature rise control for the battery using the heating device such that a temperature of the battery approaches a target temperature; and
a second management device that transmits, to the first management device, information for the first management device to set the target temperature, wherein
the first management device stores the information in the memory while the first management device is in an activated state, and
in a case where the first management device restarts,
when the second management device is in an activated state, the first management device sets the target temperature based on the information newly acquired from the second management device, and
when the second management device is in a sleep state, the first management device sets the target temperature based on the information stored in the memory.

2. The vehicle according to claim 1, wherein
the vehicle is configured to be charged by electric power supplied from a charger external to the vehicle,
the first management device is a battery controller that manages charging and discharging of the battery, and
the second management device is a charging controller that controls electric power supplied from the charger to the vehicle.

3. The vehicle according to claim 2, wherein the information indicates maximum power suppliable from the charger.

4. The vehicle according to claim 3, wherein the first management device sets the target temperature to be higher as the maximum power is larger.

5. The vehicle according to claim 1, wherein the first management device sets a time from transition into the sleep state to restart of the first management device to be shorter as an ambient temperature is lower.
